(19) United States
(12) Patent Application Publication
(10) Pub. No.: US 2025/0217704 A1
(43) Pub. Date: Jul. 3, 2025

(54) MODEL OWNERSHIP VERIFICATION METHODS AND APPARATUSES, STORAGE MEDIA, AND ELECTRONIC DEVICES

(71) Applicant: Alipay (Hangzhou) Information Technology Co., Ltd., Hangzhou (CN)

(72) Inventors: Yiming LI, Hangzhou (CN); Yan LIU, Hangzhou (CN); Linghui ZHU, Hangzhou (CN); Haiqin WENG, Hangzhou (CN); Yong JIANG, Hangzhou (CN); Shutao XIA, Hangzhou (CN)

(21) Appl. No.: 18/871,767

(22) PCT Filed: Aug. 2, 2023
(86) PCT No.: PCT/CN2023/110871

§ 371 Date: Dec. 4, 2024

(30) Foreign Application Priority Data
Sep. 20, 2022 (CN) 202211146420.1

(51) Int. Cl. G06N 20/00

(52) U.S. Cl. CPC G06N 20/00

(57) ABSTRACT

This specification discloses model ownership verification methods and apparatuses, storage media, and electronic devices. The method includes: adding a specified feature to an original sample without adjusting an annotation of the original sample, to cause an annotation of an adjusted sample to be the same as the annotation of the original sample corresponding to the adjusted sample, and in a case that ownership of the model to be verified cannot be determined through the annotations, determining whether a sample for training a model to be verified comes from an edge node based on a gradient obtained by inputting the adjusted sample into the model to be verified and a gradient obtained by inputting the adjusted sample into a benign model trained through the original sample.

### TECHNICAL FIELD

This specification relates to the field of computer technologies, and in particular, to model ownership verification methods and apparatuses, storage media, and electronic devices.

### BACKGROUND

With the development of artificial intelligence, machine learning models are widely used. Horizontal Federated learning is a type of distributed training, with a main objective being to protect private data as training samples from being leaked. Specifically, each edge node receives model parameters sent by a parameter server, generates a machine learning model through the model parameters, inputs private data locally saved by the edge node into the machine learning model as training samples, obtains a gradient based on a result output by the machine learning model and annotations corresponding to the training samples, and then uploads the obtained gradient to the parameter server, so that the parameter server can update the model parameters, so as to implement iteration.

However, although training the model in the above-mentioned way can protect the privacy data of the edge node, a model ownership problem may occur. For example, the edge node allows only the parameter server to train a specific model through the gradient uploaded by the edge node, and restricts the model to only a specific purpose. However, the parameter server may train other models through the gradient uploaded by the edge node without being allowed by the edge node, or the parameter server may use the trained model for another purpose.

Therefore, how to determine whether a model to be verified is trained through privacy data stored by an edge node becomes an urgent problem to be solved.

### SUMMARY

This specification provides model ownership verification methods and apparatuses, storage media, and electronic devices.

This specification uses the following technical solutions: This specification provides a model ownership verification method, including: acquiring an adjusted sample locally saved by an edge node and an annotation of the adjusted sample, where the adjusted sample is obtained by adding a specified feature to an original sample, and the annotation of the adjusted sample is the same as an annotation of the original sample corresponding to the adjusted sample; inputting the adjusted sample into a model to be verified, and determining a gradient of the model to be verified as a first gradient based on an output result of the model to be verified and the annotation corresponding to the adjusted sample; inputting the adjusted sample into a pre-saved benign model, and determining a gradient of the benign model as a second gradient based on an output result of the benign model and the annotation corresponding to the adjusted sample, where the benign model is obtained through training based on the original sample; and determining whether a sample for training the model to be verified comes from the edge node based on the first gradient and the second gradient.

Optionally, original samples corresponding to different adjusted samples are different, and specified features contained in the different adjusted samples are the same.

Optionally, the determining whether a sample for training the model to be verified comes from the edge node based on the first gradient and the second gradient specifically includes: inputting the first gradient and the second gradient into a pre-trained classifier, and determining whether a sample for training the model to be verified comes from the edge node by the classifier.

Optionally, pre-training the classifier specifically includes: inputting the adjusted sample into a pre-saved victim model, and determining a gradient of the victim model as a third gradient based on an output result of the victim model and the annotation corresponding to the adjusted sample, where the victim model is trained based on a sample set including the original sample and the adjusted sample; and training the classifier with the second gradient and the third gradient as training samples and source models of the second gradient and the third gradient as annotations, where the source model of the second gradient is the benign model, and the source model of the third gradient is the victim model.

Optionally, the determining whether a sample for training the model to be verified comes from the edge node by the classifier specifically includes: determining that the sample of the model to be verified comes from the edge node when a result output by the classifier is that the source model of the first gradient is the victim model, or determine that the sample of the model to be verified is not from the edge node when the result output by the classifier is that the source model of the first gradient is the benign model.

Optionally, pre-training the victim model specifically includes: determining a first sample set composed of original samples and a second sample set composed of adjusted samples, and receiving a model to be trained that is sent by a parameter server; determining a gradient of the model to be trained based on the samples in the first sample set and annotations corresponding to the samples in the first sample set; sending the gradient of the model to be trained to the parameter server, so that the parameter server updates the model to be trained based on the gradient of the model to be trained; receiving an updated model to be trained that is sent by the parameter server as an intermediate model; determining a gradient of the intermediate model based on the samples in the second sample set and annotations corresponding to the samples in the second sample set; sending the gradient of the intermediate model to the parameter server, so that the parameter server updates the intermediate model based on the gradient of the intermediate model to obtain the victim model; and receiving and storing the victim model sent by the parameter server.

Optionally, after the receiving an updated model to be trained that is sent by the parameter server as an intermediate model, the method further includes: saving the intermediate model as a benign model.

This specification provides a model ownership verification apparatus, including: an acquisition module, configured to acquire an adjusted sample locally saved by an edge node and an annotation of the adjusted sample, where the adjusted sample is obtained by adding a specified feature to an original sample, and the annotation of the adjusted sample is the same as an annotation of the original sample corresponding to the adjusted sample; a gradient determining module, configured to input the adjusted sample into a model to be verified, and determine a gradient of the model to be verified as a first gradient based on an output result of the model to be verified and the annotation corresponding to the adjusted sample; input the adjusted sample into a pre-saved benign model, and determine a gradient of the benign model as a second gradient based on an output result of the benign model and the annotation corresponding to the adjusted sample, where the benign model is obtained through training based on the original sample; and a verification module, configured to determine whether a sample for training the model to be verified comes from the edge node based on the first gradient and the second gradient.

Optionally, original samples corresponding to different adjusted samples are different, and specified features contained in the different adjusted samples are the same.

Optionally, the verification module is specifically configured to input the first gradient and the second gradient into a pre-trained classifier, and determine whether a sample for training the model to be verified comes from the edge node by the classifier.

Optionally, the apparatus further includes: a first training module, configured to input the adjusted sample into a pre-saved victim model, and determine a gradient of the victim model as a third gradient based on an output result of the victim model and the annotation corresponding to the adjusted sample, where the victim model is trained based on a sample set including the original sample and the adjusted sample; and train the classifier with the second gradient and the third gradient as training samples and source models of the second gradient and the third gradient as annotations, where the source model of the second gradient is the benign model, and the source model of the third gradient is the victim model.

Optionally, the verification module is specifically configured to determine that the sample of the model to be verified comes from the edge node when a result output by the classifier is that the source model of the first gradient is the victim model, or determine that the sample of the model to be verified is not from the edge node when the result output by the classifier is that the source model of the first gradient is the benign model.

Optionally, the apparatus further includes: a second training module, configured to determine a first sample set composed of original samples and a second sample set composed of adjusted samples, and receive a model to be trained that is sent by a parameter server; determine a gradient of the model to be trained based on the samples in the first sample set and annotations corresponding to the samples in the first sample set; send the gradient of the model to be trained to the parameter server, so that the parameter server updates the model to be trained based on the gradient of the model to be trained; receive an updated model to be trained that is sent by the parameter server as an intermediate model; determine a gradient of the intermediate model based on the samples in the second sample set and annotations corresponding to the samples in the second sample set; send the gradient of the intermediate model to the parameter server, so that the parameter server updates the intermediate model based on the gradient of the intermediate model to obtain the victim model; and receive and store the victim model sent by the parameter server.

Optionally, after the second training module receives the updated model to be trained that is sent by the parameter server as the intermediate model, the gradient determining module is further configured to save the intermediate model as a benign model.

This specification provides a computer-readable storage medium. The storage medium stores a computer program, and when the computer program is executed by a processor, the above-mentioned model ownership verification method is implemented.

This specification provides an electronic device, including a storage, a processor, and a computer program stored in the storage and capable of running on the processor, where when the processor executes the program, the above-mentioned model ownership verification method is implemented.

The above-mentioned at least one technical solution used in this specification can achieve the following beneficial effects: In the model ownership verification method according to this specification, a specified feature is added to an original sample without adjusting an annotation of the original sample, to cause an annotation of an adjusted sample to be the same as the annotation of the original sample corresponding to the adjusted sample, and whether a sample for training a model to be verified comes from an edge node is determined based on a gradient obtained by inputting the adjusted sample into the model to be verified and a gradient obtained by inputting the adjusted sample into a benign model trained through the original sample.

As can be learned from the above-mentioned method, in the method, since the annotation of the adjusted sample and the annotation of the original sample corresponding to the adjusted sample are the same, in a case that ownership of the model to be verified cannot be determined through the annotations, whether a sample for training the model to be verified comes from the edge node is determined through different gradient performance of the adjusted sample in the model to be verified and the benign model, so that the ownership of the model to be verified can be determined more accurately.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification.

FIG. 1 is a schematic flowchart illustrating a model ownership verification method, according to this specification;

FIG. 2 is a schematic diagram illustrating a training process of a victim model, according to this specification;

FIG. 3 is a schematic diagram illustrating a model ownership verification apparatus, according to this specification; and

FIG. 4 is a schematic diagram illustrating an electronic device corresponding to FIG. 1, according to this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of the embodiments of this specification. Based on the embodiments of this specification, all other embodiments obtained by a person of ordinary skill in the art without creative efforts shall fall within the protection scope of this specification.

As mentioned above, how to determine whether a sample for training a model to be verified comes from an edge node becomes an urgent problem to be solved. Currently, in a process of training the model, a watermark can be embedded into the training sample first. Embedding the watermark is to embed atomic information of the watermark into data with different features. For example, if the training sample is an image, embedding the watermark can change a pixel value of the image, and then adjust an annotation of the sample. In a process of ownership verification of the model to be verified, the sample with an embedded watermark is input to the model to be verified. If an output is an adjusted annotation, the model to be verified is trained based on the training sample and the sample with a watermark. However, an operation of embedding a watermark poses a new security threat of leaving a backdoor in the model, and due to the adjustment of the annotation of the sample, the model may make a prediction error during use. For example, if a model that needs to be trained is a binary classification model, there are two output results, namely category A and category B. In the process of training the model, when the original sample and the sample with an embedded watermark are used for training, annotations of the original sample are category A and category B, while the annotation of the sample with an embedded watermark is category C. In the process of verifying the model to be verified, the sample with an embedded watermark is input to the model to be verified. When the output result is category C, it can be determined that the model to be verified is trained based on the training sample and the sample with a watermark. However, when using the model, a parameter server mistakenly believes that the model can output only category A and category B because the parameter server does not know that the model is actually a model that can output three results, category A, category B, and category C. Therefore, when the model is applied to a certain service, the service can only be in such a configuration that Y operation processing is performed when the output result of the model is category A, while N operation processing is performed when the output result of the model is category B. However, when the model is used in the service, if the sample input into the model is similar to the sample with an embedded watermark, which causes the output result of the model to be category C. a result that cannot be handled occurs. As a result, an error occurs during the use of the model, thereby greatly affecting prediction accuracy of the model and reducing prediction accuracy of the model.

Therefore, embodiments of this specification provide a model ownership verification method and apparatus, a storage medium, and an electronic device. The technical solutions provided in the embodiments of this specification are described below in detail with reference to accompanying drawings.

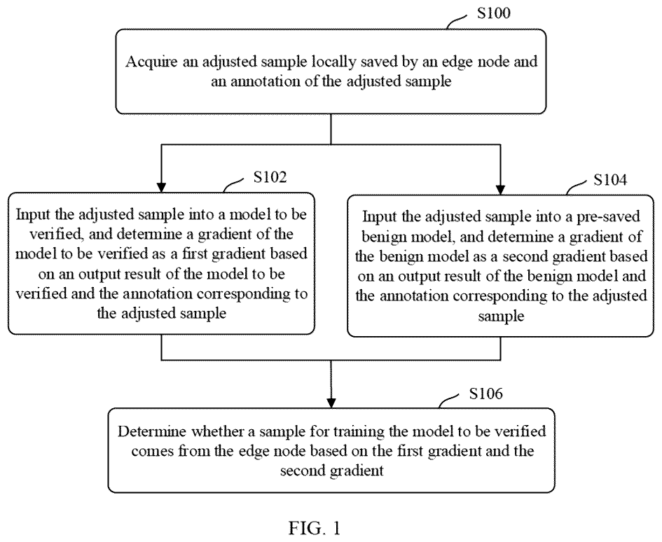

FIG. 1 is a schematic flowchart illustrating a model ownership verification method, according to this specification. The method includes step S100 to step S106.

S100: An adjusted sample locally saved by an edge node and an annotation of the adjusted sample are acquired.

In practical applications, horizontal Federated learning is a type of distributed training, mainly as follows: Each edge node receives model parameters sent by a parameter server, generates a machine learning model through the model parameters, inputs sample data locally saved by the edge node into the machine learning model as training samples, obtains a gradient based on a result output by the machine learning model and annotations corresponding to the training samples, and then uploads the obtained gradient to the parameter server, so that the parameter server can update the model parameters, so as to implement iteration. The edge nodes cooperate to train the machine learning model, which can improve training efficiency of the machine learning model, but a model ownership problem may occur.

To know whether a model to be verified is trained based on private data saved by an edge node (that is, to verify whether ownership of the model to be verified belongs to the edge node), in this specification, a method of training the model by original samples and some adjusted samples (that is, the above-mentioned samples with embedded watermarks) in a stage of training the model is still used without changing annotations corresponding to the adjusted samples, but whether the ownership of the model to be verified belongs to the edge node is verified by another method, to avoid the problem of model accuracy decline caused by changing the annotations of the samples.

Based on this, in this specification, the edge node acquires the locally saved adjusted samples and the annotations of the adjusted samples. The edge node can be an edge node that uses local original samples to participate in training of the machine learning model, or another node that the edge node trusts. This is not specifically limited here. For ease of explanation, only an edge node being an execution body is used for explanation below.

The adjusted sample is obtained by adding a specified feature to the locally saved original sample, without adjusting the annotation of the sample. Specifically, the specified feature can be set based on sample data of the original sample. For example, when a machine learning model being trained is a model related to natural language processing, and sample data of an original sample is text information, a specified feature can be specific text, and the sample can be adjusted by adding specific text to the text information. An annotation of the sample is not changed while the sample is adjusted. When a machine learning model being trained is a model related to speech recognition, and sample data of an original sample is speech information, a specified feature can be a non-natural sound such as specific noise, and the sample can be adjusted by adding specific noise to the speech information. An annotation of the sample is not changed while the sample is adjusted. When a machine learning model being trained is a model related to image processing or classification, and sample data of an original sample is an image, a specified feature can be an image style, and the sample can be adjusted by transferring the style of the sample image based on a given image style. An annotation of the sample is not changed while the sample is adjusted. The sample to which the specified feature is added, that is, the adjusted sample, is different from a corresponding original sample. Specified features contained in different adjusted samples are the same. This is to cause the model to learn the same specified feature contained in different adjusted samples when the adjusted samples are used to train the model, so that when the adjusted samples are input to the model, the model recognizes the specified feature and determines that the input samples are the adjusted samples, and therefore output results are annotations of the adjusted samples.

The edge node can verify the ownership of the model to be verified by applying the model ownership verification method according to this specification, so as to determine whether a sample for training the model to be verified comes from the edge node.

S102: The adjusted sample is input into a model to be verified, and a gradient of the model to be verified is determined as a first gradient based on an output result of the model to be verified and the annotation corresponding to the adjusted sample.

S104: The adjusted sample is input into a pre-saved benign model, and a gradient of the benign model is determined as a second gradient based on an output result of the benign model and the annotation corresponding to the adjusted sample.

The edge node only allows the parameter server to train a specific model by using the uploaded gradient, and restricts the model to only a specific purpose. If the edge node suspects that a certain model may be trained through the gradient uploaded to the parameter server by the edge node, or finds that a trained model is used by the parameter server for a purpose other than a specific purpose, the model can be verified as a model to be verified.

Specifically, in step S104, the adjusted sample is input into the pre-saved benign model to obtain an output result, the output result of the benign model and the annotation corresponding to the adjusted sample are input into a loss function to calculate a gradient, and the calculated gradient is taken as a second gradient. The benign model is trained through the original sample, and the loss function is used in the process of training the benign model. In step S102, the edge node needs to input the above-mentioned adjusted sample into the model to be verified to obtain an output result, input the output result of the model to be verified and the annotation corresponding to the adjusted sample into the above-mentioned same loss function to calculate a gradient, and take the calculated gradient as a first gradient.

Steps S102 and S104 are performed in no order.

S106: Whether a sample for training the model to be verified comes from the edge node is determined based on the first gradient and the second gradient.

In step S100, since the annotations of the adjusted sample and the original sample corresponding to the adjusted sample are the same, even if the adjusted sample is input into a model trained in advance through the adjusted sample and the original sample (the ownership of the model belongs to the edge node), there is no special output result of the model. Therefore, it is impossible to determine the ownership of the model to be verified based on the output result of the model. In this case, in this specification, whether a sample for training the model to be verified comes from the edge node is determined through gradient performance of the adjusted sample in the model to be verified and the benign model.

Since the benign model is trained through the original sample without using the adjusted sample, if the ownership of the model to be verified belongs to the edge node, the model to be verified must have been trained through the adjusted sample, or if the ownership of the model to be verified does not belong to the edge node, the model to be verified must not have been trained through the adjusted sample. Whether a model has been trained through a specific sample can be determined by observing a reflection of the model on the sample after the specific sample is input into the model. The reflection of the aforementioned model on a specific sample in this specification is represented by the gradient of the model calculated after the sample is input into the model. Since the benign model is not trained through the adjusted sample, after the adjusted sample is input into the benign model and the model to be verified. if the model to be verified also is not trained through the adjusted sample, the benign model and the model to be verified should have similar reflections on the input adjusted sample, that is, gradients of the two models are similar. On the contrary, if the model to be verified has been trained through the adjusted sample, reflections of the benign model and the model on the input adjusted sample should be completely different, that is, the gradients of the two models are not similar.

Therefore, whether a sample for training the model to be verified comes from the edge node can be determined based on a similarity between the first gradient and the second gradient obtained in steps S102 and S104. Specifically, a plurality of adjusted samples can be input into the benign model and the model to be verified, so as to obtain a plurality of second gradients of the benign model based on the plurality of adjusted samples and a plurality of first gradients of the model to be verified based on the plurality of adjusted samples respectively. Then a first feature vector is determined based on the plurality of first gradients, and a second feature vector is determined based on the plurality of second gradients. Finally a similarity between the first feature vector and the second feature vector is calculated. If the similarity is greater than a predetermined threshold, it is determined that ownership of the model to be verified does not belong to the edge node, otherwise, it is determined that the ownership of the model to be verified belongs to the edge node.

For example, 100 adjusted samples can be input into the benign model, 100 corresponding second gradients can be obtained based on obtained output results and annotations corresponding to the adjusted samples, and a second feature vector composed of the 100 second gradients as elements can be determined. Correspondingly, the 100 adjusted samples can be also input into the model to be verified to obtain a first feature vector, and finally, whether a sample for training the model to be verified comes from the edge node can be determined based on a similarity between the first feature vector and the second feature vector.

Based on the model ownership verification method shown in FIG. 1, a specified feature is added to each original sample without adjusting an annotation of the original sample, so that different adjusted samples contain the same specified feature, and an annotation of each adjusted sample is the same as the annotation of the original sample corresponding to the adjusted sample. Whether a sample for training a model to be verified comes from an edge node is determined based on gradients obtained by inputting the adjusted samples into the model to be verified and gradients obtained by inputting the adjusted samples into a benign model trained through the original samples.

As can be learned from the above-mentioned method, in the method, because the annotation of each original sample is not adjusted when the specified feature is added to the original sample, the annotation of the adjusted sample and the annotation of the original sample corresponding to the adjusted sample are the same, and therefore ownership of the model to be verified cannot be determined through the annotations. In this case, whether a sample for training the model to be verified comes from the edge node is determined through different gradient performance of the adjusted sample in the model to be verified and the benign model, so that the ownership of the model to be verified can be determined more accurately. In addition, although the original samples and the adjusted samples are used to train the model, the annotation of each sample is not changed when the sample is adjusted, and the annotation of each adjusted sample is the same as the annotation of the original sample corresponding to the adjusted sample. Therefore, during use of the model by the parameter server, if input sample data have a feature similar to the specified feature contained in the adjusted sample, an output result is the annotation of the original sample corresponding to the adjusted sample, and there is no result different from the annotation of the original sample. This does not affect a subsequent operation of the parameter server, does not cause a prediction error in the model during use, does not have a significant impact on prediction precision of the model, and does not reduce prediction accuracy of the model.

The model ownership verification method shown in FIG. 1 can be used to determine whether a sample for training the model to be verified comes from an edge node. To implement the determining through gradient performance of the adjusted samples in the benign model and the model to be verified, the adjusted samples need to be input into the model to be verified and the benign model to obtain a plurality of first gradients and second gradients respectively, and a corresponding first feature vector and second feature vector are calculated through the obtained first gradients and second gradients. Then a similarity between the first feature vector and the second feature vector is calculated, and whether the ownership of the model to be verified belongs to the edge node is determined based on the similarity and the predetermined threshold. By the above-mentioned method, whether a sample for training the model to be verified comes from the edge node is determined based on different gradient performance of the adjusted samples in the benign model and the model to be verified. Theoretically, the determining can be performed through whether the first gradients and the second gradients are similar, but in practice, a rule for determining whether a sample for training the model to be verified comes from the edge node or not through specific features of the gradients obtained by inputting the adjusted samples into the model to be verified cannot be artificially quantified very easily. Based on this, a machine learning model can be used to learn features of the second gradients. Therefore, when the first gradients are input to the machine learning model, the model makes a comparison with the first gradients based on the learned features of the second gradients, and determines whether the first gradients have features of the second gradients. If so, the sample for training the model to be verified does not come from the edge node; if not, the sample for training the model to be verified comes from the edge node.

Specifically, a classifier can be pre-trained, a first gradient and a second gradient can be input into the pre-trained classifier, and whether a sample for training the model to be verified comes from the edge node can be determined based on an output result of the classifier.

During the training of the above-mentioned classifier, the adjusted sample can be first input into a pre-saved victim model to obtain an output result, the output result of the victim model and the annotation corresponding to the adjusted sample are input into a loss function to calculate a gradient, and the calculated gradient is taken as a third gradient. The victim model is trained based on the original sample and the adjusted sample, and the loss function is used in the process of training the victim model. Then the classifier is trained with the second gradient and the third gradient as training samples and source models of the second gradient and the third gradient as annotations, where the source model of the second gradient is the benign model, and the source model of the third gradient is the victim model. Because the victim model is trained through the original sample and the adjusted sample, when the first gradient is input into the pre-trained classifier, if a result output by the classifier is that a source model of the first gradient is a victim model, the model to be verified was trained through an adjusted sample, and the sample for training the model to be verified comes from the edge node. If the result output by the classifier is that the source model of the first gradient is a benign model, the model to be verified was not trained through an adjusted sample, and a sample for training the model to be verified does not come from the edge node.

The first gradient and the second gradient are input into the pre-trained classifier, so that whether a sample for training the model to be verified comes from the edge node is determined based on the output results of the classifier, with no need to artificially set a rule for determining a sample of the model to be trained comes from the edge node. The classifier can be trained to learn features of the second gradient and the third gradient. Then the first gradient is input into the classifier, and whether the sample of the model to be trained comes from the edge node can be determined based on the output result. When the output result is that the source model of the first gradient is a victim model, the sample of the model to be verified comes from the edge node; or when the output result is that the source model of the first gradient is a benign model, the sample of the model to be verified does not from the edge node.

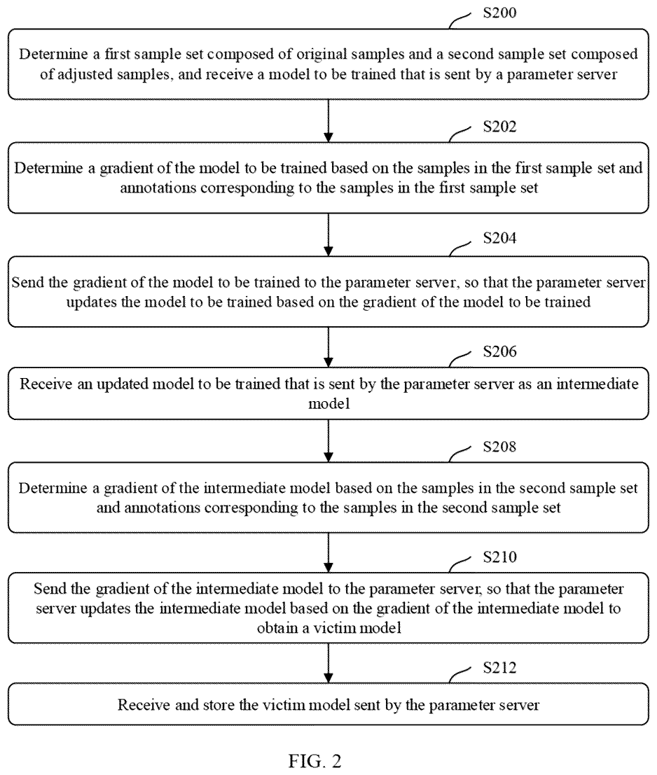

In some embodiments of this specification, the above-mentioned victim model is essentially a model trained by the parameter server with the assistance of the edge node in the horizontal Federated training process, that is, the model that the parameter server needs to apply to a service subsequently is the above-mentioned victim model, and the training process of the victim model can be shown in FIG. 2.

FIG. 2 is a schematic diagram illustrating a training process of a victim model. The process can specifically include step S200 to step S212.

S200: A first sample set composed of original samples and a second sample set composed of adjusted samples is determined, and a model to be trained that is sent by a parameter server is received.

S202: A gradient of the model to be trained is determined based on the samples in the first sample set and annotations corresponding to the samples in the first sample set.

The edge node inputs a first sample into the model to be trained, inputs an obtained output result and an annotation corresponding to the first sample into a loss function, calculates a loss based on the loss function, and determines a gradient that minimizes the loss. The loss function is the loss function used in the training process of the above-mentioned model to be trained, and is also the loss function mentioned in step S102 and step S104.

S204: The gradient of the model to be trained is sent to the parameter server, so that the parameter server updates the model to be trained based on the gradient of the model to be trained.

S206: An updated model to be trained that is sent by the parameter server is received as an intermediate model.

The edge node can iteratively train the model to be trained for multiple times by the method shown in steps S202 to S204. Assuming that if the model to be trained has been trained for n times through a sample, it is believed that the training of the model to be trained is completed and a desired effect is achieved, the edge node can use the first sample to train the model for n-i times by the method shown in steps S202 to S204. In step S206, the model to be trained that has been trained for n-i times is taken as an intermediate model. n and i are set positive integers.

S208: A gradient of the intermediate model is determined based on the samples in the second sample set and annotations corresponding to the samples in the second sample set.

The edge node inputs a second sample into the intermediate model, inputs an obtained output result and an annotation corresponding to the second sample into a loss function, calculates a loss based on the loss function, and determines a gradient that minimizes the loss.

S210: The gradient of the intermediate model is sent to the parameter server, so that the parameter server updates the intermediate model based on the gradient of the intermediate model to obtain the victim model.

Similar to steps S202 to S204, the edge node can alternatively train the intermediate model for i times through steps S208 to S210, and send a gradient obtained each time the second sample is input in training for i times to the parameter server, so that the parameter server can update the intermediate model based on the above-mentioned gradient and save a model updated for i times as a victim model. The victim model is a model trained by the parameter server with the assistance of the edge node, and the parameter server applies the victim model to a subsequent service.

However, the parameter server may use the gradient uploaded by the edge node to train another model without the authorization of the edge node, or use the saved victim model for another purpose. However, the victim model saved by the parameter server is a model trained through the second sample. If the model to be verified is a model trained through the second sample, the ownership of the model to be verified belongs to the edge node, or if the model to be verified is a model not trained through the second sample, the ownership of the model to be verified does not belong to the edge node.

S212: The victim model sent by the parameter server is received and stored.

The edge node receives the victim model sent by the parameter server, and saves the victim model for use when the aforementioned classifier is trained. The adjusted sample is input into the victim model, and the third gradient is determined based on the obtained output result and the annotation corresponding to the adjusted sample. The classifier is trained with the third gradient as a sample for training the classifier and a source model of the third gradient as an annotation of the sample. The edge node saves the intermediate model in step S206 as a benign model, and the benign model saved here is the benign model pre-saved in step S104. In fact, the benign model and the victim model are models in two training stages in the process of training the model to be trained by the parameter server with the assistance of the edge node. The benign model is a model obtained by training the model to be trained through the first sample, that is, the intermediate model, and the victim model is a model obtained by training the intermediate model through the second sample. The victim model is a model that the parameter server can ultimately apply to a service.

In other words, when using the embodiments of this specification to verify the ownership issue of the model to be verified, the edge node needs to save, during the process of assisting the parameter server in model training, the benign model trained through the original sample. Based on the benign model, the adjusted sample is used for training, and the victim model trained through the adjusted sample is also saved. Then, a classifier is trained through the saved benign model and victim model, and the ownership of the model to be verified is determined by the classifier. Finally, the parameter server saves the victim model trained through the adjusted sample and applies the victim model to a service.

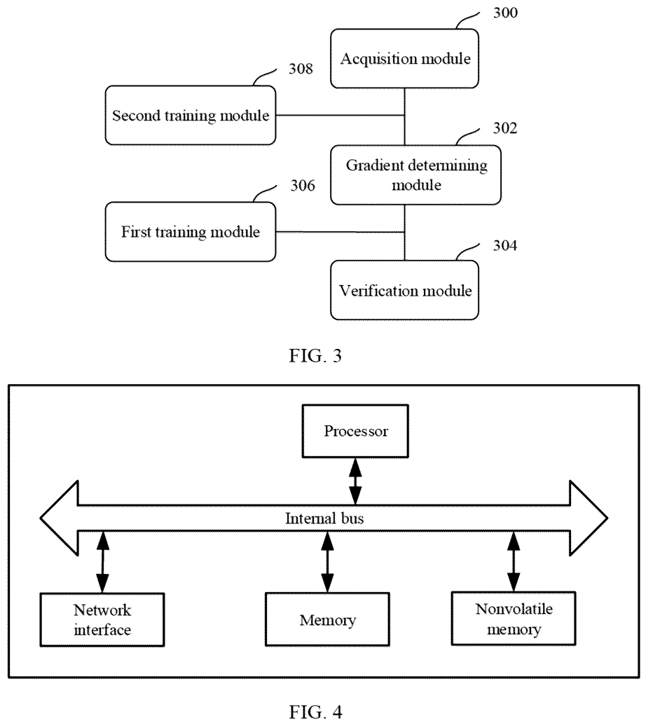

The model ownership verification method according to one or more embodiments of this specification is described above. Based on the same idea, this specification further provides a corresponding model ownership verification apparatus, as shown in FIG. 3.

FIG. 3 is a schematic diagram illustrating a model ownership verification apparatus, according to this specification. The apparatus specifically includes: an acquisition module 300, configured to acquire an adjusted sample locally saved by an edge node and an annotation of the adjusted sample, where the adjusted sample is obtained by adding a specified feature to an original sample, and the annotation of the adjusted sample is the same as an annotation of the original sample corresponding to the adjusted sample; a gradient determining module 302. configured to input the adjusted sample into a model to be verified, and determine a gradient of the model to be verified as a first gradient based on an output result of the model to be verified and the annotation corresponding to the adjusted sample; input the adjusted sample into a pre-saved benign model, and determine a gradient of the benign model as a second gradient based on an output result of the benign model and the annotation corresponding to the adjusted sample, where the benign model is obtained through training based on the original sample; and a verification module 304, configured to determine whether a sample for training the model to be verified comes from the edge node based on the first gradient and the second gradient.

Optionally, original samples corresponding to different adjusted samples are different, and specified features contained in the different adjusted samples are the same.

Optionally, the verification module 304 is specifically configured to input the first gradient and the second gradient into a pre-trained classifier, and determine whether a sample for training the model to be verified comes from the edge node by the classifier.

Optionally, the apparatus further includes: a first training module 306, configured to input the adjusted sample into a pre-saved victim model, and determine a gradient of the victim model as a third gradient based on an output result of the victim model and the annotation corresponding to the adjusted sample, where the victim model is trained based on a sample set including the original sample and the adjusted sample; and train the classifier with the second gradient and the third gradient as training samples and source models of the second gradient and the third gradient as annotations, where the source model of the second gradient is the benign model, and the source model of the third gradient is the victim model.

Optionally, the verification module 304 is specifically configured to determine that the sample of the model to be verified comes from the edge node when a result output by the classifier is that the source model of the first gradient is the victim model, or determine that the sample of the model to be verified is not from the edge node when the result output by the classifier is that the source model of the first gradient is the benign model.

Optionally, the apparatus further includes: a second training module 308, configured to determine a first sample set composed of original samples and a second sample set composed of adjusted samples, and receive a model to be trained that is sent by a parameter server; determine a gradient of the model to be trained based on the samples in the first sample set and annotations corresponding to the samples in the first sample set; send the gradient of the model to be trained to the parameter server, so that the parameter server updates the model to be trained based on the gradient of the model to be trained; receive an updated model to be trained that is sent by the parameter server as an intermediate model; determine a gradient of the intermediate model based on the samples in the second sample set and annotations corresponding to the samples in the second sample set; send the gradient of the intermediate model to the parameter server, so that the parameter server updates the intermediate model based on the gradient of the intermediate model to obtain the victim model; and receive and store the victim model sent by the parameter server.

Optionally, after the second training module 308 receives the updated model to be trained that is sent by the parameter server as the intermediate model, the gradient determining module 302 is further configured to save the intermediate model as a benign model.

This specification provides a computer-readable storage medium. The storage medium stores a computer program, and the computer program can be used to perform the model ownership verification method provided in FIG. 1.

This specification further provides a schematic diagram illustrating a structure of an electronic device shown in FIG. 4. As shown in FIG. 4, in terms of hardware, the electronic device includes a processor, an internal bus, a network interface, a memory, and a nonvolatile memory, and certainly can further include hardware needed by another service. The processor reads a corresponding computer program from the nonvolatile memory into the memory and then runs the computer program, to implement the model ownership verification method of FIG. 1. Certainly, in addition to software implementations, another implementation is not excluded in this specification, for example, a logic device or a combination of hardware and software. In other words, an execution body of the following processing process is not limited to logical units, and can be hardware or a logic device.

In the 1990s, improvements to a technology could clearly be distinguished as improvements in hardware (for example, improvements to circuit structures such as diodes, transistors, and switches) or software (improvements to method procedures). However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a specific programming language before being compiled. The language is referred to as a hardware description language (HDL). There are many HDLs. such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the above-mentioned several hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can alternatively be implemented as a part of control logic of the storage. A person skilled in the art also knows that, in addition to implementing the controller by using only computer-readable program code, logic programming can be performed on a method step, so the controller implements a same function in a form of a logic gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Or the apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that the embodiments of this specification can be provided as methods, systems, or computer program products. Therefore, this specification can use a form of hardware only embodiments, software only embodiments, or embodiments with a combination of software and hardware. In addition, this specification can use a form of a computer program product that is implemented on one or more computer-usable storage media (including but not limited to a disk storage, a CD-ROM, an optical storage, or the like) that include computer-usable program code.

This specification is described with reference to flowcharts and/or block diagrams of a method, a device (system), and a computer program product according to embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

These computer program instructions can alternatively be stored in a computer-readable memory that can instruct a computer or another programmable data processing device to work in a specific way, so that an instruction stored in the computer-readable memory generates an artifact including an instruction apparatus, and the instruction apparatus implements a specified function in one or more procedures in the flowcharts and/or one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), an input/output interface, a network interface, and a memory.

The memory may include a form such as a non-permanent memory, a random access memory (RAM), and/or a nonvolatile memory in a computer-readable medium, for example, a read-only memory (ROM) or a flash memory (flash RAM). The memory is an example of the computer-readable medium

Computer-readable media, including permanent and non-permanent, removable and non-removable media, can implement information storage by any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory computer-readable media (transitory media) such as a modulated data signal and carrier.

It is worthwhile to further note that the terms “include”, “comprise”, or any other variants thereof are intended to cover a non-exclusive inclusion, so that a process, method, product, or device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, this specification can use a form of a computer program product that is implemented on one or more computer-usable storage media (including but not limited to a disk storage, a CD-ROM, an optical storage, or the like) that include computer-usable program code.

This specification can be described in a general context of a computer-executable instruction executed by a computer, for example, a program module. Generally, the program module includes a routine, a program, an object, a component, a data structure, etc. for executing a specific task or implementing a specific abstract data type. This specification can alternatively be practiced in distributed computing environments in which tasks are performed by remote processing devices that are connected through a communication network. In the distributed computing environment, a program module can be located in local and remote computer storage media including a storage device.

The embodiments of this specification are described in a progressive way. For same or similar parts in the embodiments, mutual reference can be made to the embodiments. Each embodiment focuses on a difference from other embodiments. Particularly, the system embodiments are basically similar to the method embodiments, and therefore are briefly described. For a related part, reference can be made to some descriptions in the method embodiments.

The above-mentioned descriptions are embodiments of this specification and are not intended to limit this specification. A person skilled in the art can make various changes and variations to this specification. Any modification, equivalent replacement, improvement, etc. made without departing from the spirit and principle of this specification shall fall within the scope of the claims in this specification.

1. A model ownership verification method, comprising:
acquiring an adjusted sample locally saved by an edge node and an annotation of the adjusted sample, wherein the adjusted sample is obtained by adding a specified feature to an original sample, and the annotation of the adjusted sample is the same as an annotation of the original sample corresponding to the adjusted sample;
inputting the adjusted sample into a model to be verified, and determining a gradient of the model to be verified as a first gradient based on an output result of the model to be verified and the annotation corresponding to the adjusted sample; inputting the adjusted sample into a pre-saved benign model, and determining a gradient of the benign model as a second gradient based on an output result of the benign model and the annotation corresponding to the adjusted sample, wherein the benign model is obtained through training based on the original sample; and
determining whether a sample for training the model to be verified comes from the edge node based on the first gradient and the second gradient.

2. The method according to claim 1, wherein original samples corresponding to different adjusted samples are different, and specified features contained in the different adjusted samples are the same.

3. The method according to claim 1, wherein determining whether the sample for training the model to be verified comes from the edge node based on the first gradient and the second gradient specifically comprises:
inputting the first gradient and the second gradient into a pre-trained classifier, and determining whether a sample for training the model to be verified comes from the edge node by the classifier.

4. The method according to claim 3, wherein pre-training the classifier comprises:
inputting the adjusted sample into a pre-saved victim model, and determining a gradient of the victim model as a third gradient based on an output result of the victim model and the annotation corresponding to the adjusted sample, wherein the victim model is trained based on a sample set comprising the original sample and the adjusted sample; and
training the classifier with the second gradient and the third gradient as training samples and source models of the second gradient and the third gradient as annotations, wherein the source model of the second gradient is the benign model, and the source model of the third gradient is the victim model.

5. The method according to claim 4, wherein determining whether the sample for training the model to be verified comes from the edge node by the classifier comprises:
determining that the sample of the model to be verified comes from the edge node when a result output by the classifier is that the source model of the first gradient is the victim model, or
determining that the sample of the model to be verified is not from the edge node when the result output by the classifier is that the source model of the first gradient is the benign model.

6. The method according to claim 4, wherein pre-training the victim model comprises:
determining a first sample set composed of original samples and a second sample set composed of adjusted samples, and receiving a model to be trained that is sent by a parameter server;
determining a gradient of the model to be trained based on the samples in the first sample set and annotations corresponding to the samples in the first sample set;
sending the gradient of the model to be trained to the parameter server, so that the parameter server updates the model to be trained based on the gradient of the model to be trained;
receiving an updated model to be trained that is sent by the parameter server as an intermediate model;
determining a gradient of the intermediate model based on the samples in the second sample set and annotations corresponding to the samples in the second sample set;
sending the gradient of the intermediate model to the parameter server, so that the parameter server updates the intermediate model based on the gradient of the intermediate model to obtain the victim model; and
receiving and storing the victim model sent by the parameter server.

7. The method according to claim 6, wherein after the receiving an updated model to be trained that is sent by the parameter server as an intermediate model, the method further comprises:
saving the intermediate model as a benign model.

8-14. (canceled)

15. A non-transitory computer-readable storage medium, wherein the storage medium stores a computer program, and when the computer program is executed by a processor, the processor is caused to:
acquire an adjusted sample locally saved by an edge node and an annotation of the adjusted sample, wherein the adjusted sample is obtained by adding a specified feature to an original sample, and the annotation of the adjusted sample is the same as an annotation of the original sample corresponding to the adjusted sample;
input the adjusted sample into a model to be verified, and determine a gradient of the model to be verified as a first gradient based on an output result of the model to be verified and the annotation corresponding to the adjusted sample; inputting the adjusted sample into a pre-saved benign model, and determine a gradient of the benign model as a second gradient based on an output result of the benign model and the annotation corresponding to the adjusted sample, wherein the benign model is obtained through training based on the original sample; and
determine whether a sample for training the model to be verified comes from the edge node based on the first gradient and the second gradient.

16. An electronic device, comprising a storage, a processor, and a computer program stored in the storage and capable of running on the processor, wherein when the processor executes the program, the electronic device is caused to:
acquire an adjusted sample locally saved by an edge node and an annotation of the adjusted sample, wherein the adjusted sample is obtained by adding a specified feature to an original sample, and the annotation of the adjusted sample is the same as an annotation of the original sample corresponding to the adjusted sample;
input the adjusted sample into a model to be verified, and determine a gradient of the model to be verified as a first gradient based on an output result of the model to be verified and the annotation corresponding to the adjusted sample; inputting the adjusted sample into a pre-saved benign model, and determine a gradient of the benign model as a second gradient based on an output result of the benign model and the annotation corresponding to the adjusted sample, wherein the benign model is obtained through training based on the original sample; and
determine whether a sample for training the model to be verified comes from the edge node based on the first gradient and the second gradient.

17. The electronic device according to claim 16, wherein original samples corresponding to different adjusted samples are different, and specified features contained in the different adjusted samples are the same.

18. The electronic device according to claim 16, wherein the electronic device being caused to determine whether the sample for training the model to be verified comes from the edge node based on the first gradient and the second gradient specifically includes being caused to:
input the first gradient and the second gradient into a pre-trained classifier, and determine whether a sample for training the model to be verified comes from the edge node by the classifier.

19. The electronic device according to claim 18, wherein the electronic device being caused to pre-train the classifier includes being caused to:
input the adjusted sample into a pre-saved victim model, and determine a gradient of the victim model as a third gradient based on an output result of the victim model and the annotation corresponding to the adjusted sample, wherein the victim model is trained based on a sample set comprising the original sample and the adjusted sample; and
train the classifier with the second gradient and the third gradient as training samples and source models of the second gradient and the third gradient as annotations, wherein the source model of the second gradient is the benign model, and the source model of the third gradient is the victim model.

20. The electronic device according to claim 19, wherein the electronic device being caused to determine whether the sample for training the model to be verified comes from the edge node by the classifier includes being caused to:
determine that the sample of the model to be verified comes from the edge node when a result output by the classifier is that the source model of the first gradient is the victim model, or
determine that the sample of the model to be verified is not from the edge node when the result output by the classifier is that the source model of the first gradient is the benign model.

21. The electronic device according to claim 19, wherein the electronic device being caused to pre-train the victim model includes being caused to:
determine a first sample set composed of original samples and a second sample set composed of adjusted samples, and receive a model to be trained that is sent by a parameter server;
determine a gradient of the model to be trained based on the samples in the first sample set and annotations corresponding to the samples in the first sample set;
send the gradient of the model to be trained to the parameter server, so that the parameter server updates the model to be trained based on the gradient of the model to be trained;
receive an updated model to be trained that is sent by the parameter server as an intermediate model;
determine a gradient of the intermediate model based on the samples in the second sample set and annotations corresponding to the samples in the second sample set;
send the gradient of the intermediate model to the parameter server, so that the parameter server updates the intermediate model based on the gradient of the intermediate model to obtain the victim model; and
receive and store the victim model sent by the parameter server.

22. The electronic device according to claim 21, wherein after receiving the updated model to be trained which is sent by the parameter server as an intermediate model, the electronic device is further caused to:
save the intermediate model as a benign model.

23. The non-transitory computer-readable storage medium according to claim 15, wherein original samples corresponding to different adjusted samples are different, and specified features contained in the different adjusted samples are the same.

24. The non-transitory computer-readable storage medium according to claim 15, wherein the processor being caused to determine whether the sample for training the model to be verified comes from the edge node based on the first gradient and the second gradient specifically includes being caused to:
input the first gradient and the second gradient into a pre-trained classifier, and determine whether a sample for training the model to be verified comes from the edge node by the classifier.

25. The non-transitory computer-readable storage medium according to claim 24, wherein the processor being caused to pre-training the classifier includes being caused to:
input the adjusted sample into a pre-saved victim model, and determine a gradient of the victim model as a third gradient based on an output result of the victim model and the annotation corresponding to the adjusted sample, wherein the victim model is trained based on a sample set comprising the original sample and the adjusted sample; and
train the classifier with the second gradient and the third gradient as training samples and source models of the second gradient and the third gradient as annotations, wherein the source model of the second gradient is the benign model, and the source model of the third gradient is the victim model.

26. The non-transitory computer-readable storage medium according to claim 25, wherein the processor being caused to determine whether the sample for training the model to be verified comes from the edge node by the classifier includes being caused to:
determine that the sample of the model to be verified comes from the edge node when a result output by the classifier is that the source model of the first gradient is the victim model, or
determine that the sample of the model to be verified is not from the edge node when the result output by the classifier is that the source model of the first gradient is the benign model.

27. The non-transitory computer-readable storage medium according to claim 25, wherein the processor being caused to pre-train the victim model includes being caused to:
determine a first sample set composed of original samples and a second sample set composed of adjusted samples, and receive a model to be trained that is sent by a parameter server;
determine a gradient of the model to be trained based on the samples in the first sample set and annotations corresponding to the samples in the first sample set;
send the gradient of the model to be trained to the parameter server, so that the parameter server updates the model to be trained based on the gradient of the model to be trained;
receive an updated model to be trained that is sent by the parameter server as an intermediate model;
determine a gradient of the intermediate model based on the samples in the second sample set and annotations corresponding to the samples in the second sample set;
send the gradient of the intermediate model to the parameter server, so that the parameter server updates the intermediate model based on the gradient of the intermediate model to obtain the victim model; and
receive and store the victim model sent by the parameter server.
